(19) United States
(12) Patent Application Publication
(10) Pub. No.: US 2018/0083786 A1
(43) Pub. Date: Mar. 22, 2018

(54) METHODS AND SYSTEMS OF PERFORMING TAMPER-EVIDENT LOGGING USING BLOCK LATTICES

(71) Applicant: Google Inc., Mountain View, CA (US)

(72) Inventors: Timothy M. Dierks, Mountain View, CA (US); Ian Roxborough, Pacifica, CA (US); Sarah Thompson, North Riverside, IL (US); Maya Kaczorowski, Mountain View, CA (US); Smitha Sundareswaran, Santa Clara, CA (US)

(21) Appl. No.: 15/712,243

(22) Filed: Sep. 22, 2017

Related U.S. Application Data
(60) Provisional application No. 62/398,177, filed on Sep. 22, 2016.

(51) Int. Cl. H04L 9/32; G06F 21/60; G06F 21/64

(52) U.S. Cl. CPC H04L 9/3257; G06F 21/16; G06F 21/64; G06F 21/602

(57) ABSTRACT

A method of performing tamper-evident logging may include identifying an existing block in a target blockchain, where the existing block is associated with a first signature, and identifying a block of a second blockchain, where the block that is identified is associated with a second signature. The second blockchain is not a part of the target blockchain. The method includes adding a new block to the target blockchain by linking the new block to both the existing block and the block of the second blockchain that is identified by generating a signature for the new block that is based on the first signature and the second signature, and associating the signature with the new block. The target blockchain and the second blockchain may be part of a block lattice.

### CROSS-REFERENCE TO RELATED APPLICATIONS

This application claims priority to U.S. Provisional Patent Application No. 62/398,177, filed on Sep. 22, 2016 the entirety of which is included herein by reference.

### BACKGROUND

Blockchains are commonly used to provide a secure audit or log chain. A blockchain maintains a continuously-growing list of data records in blocks, with each block holding batches of individual transactions or occurrences. Each block usually includes a timestamp and a link to a previous block. As information in one block is dependent on information from a previous block, it becomes difficult to tamper with or forge a block without also changing the information of the previous blocks.

However, it is often difficult for blockchains to scale or support logs of frequent queries, while also providing strong guarantees on tamper-evidence.

### SUMMARY

Blockchains may scale more effectively and efficiently with logging that allows more efficient querying without compromising tamper-evidence. Security may also be maintained or improved.

A method of performing tamper-evident logging may include by an electronic device, identifying an existing block in a target blockchain, wherein the existing block is associated with a first signature, and by the electronic device, identifying a block of a second blockchain, where the block that is identified is associated with a second signature, where the second blockchain is not a part of the target blockchain. The method may include, by the electronic device, adding a new block to the target blockchain, by linking the new block to both the existing block and the block of the second blockchain that is identified by generating a signature for the new block that is based on the first signature and the second signature, and associating the signature with the new block. The target blockchain and the second blockchain may be part of a block lattice.

The target blockchain and the second blockchain may each be implemented as a distributed data store. They may be implemented in other structures.

The new block may comprise one or more log records that comprise one or more of the following: machine logs; data access logs; performance logs; operational logs; ledger entries; authentication logs; and/or authorization logs.

Identifying the block of the second blockchain may comprise randomly identifying a block from the second blockchain.

Identifying the block of the second blockchain may comprise: identifying a unique identifier associated with each block of the block lattice; randomly shuffling the identified unique identifiers to create a shuffled list; identifying the first unique identifier in the shuffled list; and identifying the block corresponding the first unique identifier in the shuffled list as the block of the second blockchain.

The new block may comprise one or more log records that are associated with an owner identifier; and the one or more log records of the block from the second blockchain may be associated with the owner identifier.

Generating the signature for the new block may comprise generating a block hash value associated with the new block by performing a cryptographic operation on the first signature and the second signature.

Generating the signature for the new block may comprise: generating a hash value for one or more of the one or more log records of the new block by: identifying log information from one or more log records associated with the new block, and performing a first cryptographic operation on the log information; and generating a block hash value associated with the new block by performing a second cryptographic operation on: the hash value for each of the one or more log records of the new block, the first signature, and the second signature.

The method may further comprise verifying a correctness of the block lattice by determining whether the block lattice has experienced one or more tampering events.

Verifying a correctness of the block lattice may comprise: identifying a block from the block lattice that comprises an oldest record; determining a signature for the identified block and confirming that the determined signature matches a signature that is associated with the block that comprises the oldest record; for one or more blocks in the block lattice: determining a confirmatory signature associated with the block by calculating a signature of the block and a preceding block in the block lattice, wherein the preceding block immediately precedes the block in the block lattice; and determining whether the confirmatory signature associated with the identified block matches a signature that is associated with the block.

Verifying a correctness of the block lattice may comprise: identifying a sublattice of the block lattice; identifying a block from the sublattice that comprises an oldest record; determining a signature for the identified block and confirming that the determined signature matches a signature that is associated with the block that comprises the oldest record; for one or more blocks in the sublattice: determining a confirmatory signature associated with the block by calculating a signature of the block and a preceding block in the block lattice, wherein the preceding block immediately precedes the block in the sublattice; and determining whether the confirmatory signature associated with the identified block matches a signature that is associated with the block.

Verifying a correctness of the block lattice may comprise: identifying all of the blocks in the block lattice; randomly shuffling the blocks and generating a sequenced list of the randomly shuffled blocks; and traversing the sequenced list from a first block in the sequenced list to a last block in the sequenced list by, for each block in the sequenced list; determining a confirmatory signature associated with the block by calculating a signature of the block and a preceding block in the block lattice if there is one, wherein the preceding block immediately precedes the block in the sublattice, and determining whether the confirmatory signature associated with the identified block matches a signature that is associated with the block.

A system of performing tamper-evident logging may include an electronic device and a computer-readable storage medium comprising one or more programming instructions that, when executed, cause the electronic device to perform one or more actions, such as, for example, one or more of the methods or steps described in this disclosure.

It should be noted that any feature described above may be used with any particular aspect or embodiment of the this disclosure.

### BRIEF DESCRIPTION OF THE DRAWINGS

FIG. 1 illustrates an example blockchain according to an embodiment.

FIG. 2 illustrates a flow chart of an example method of performing tamper-evident logging according to an embodiment.

FIG. 3 illustrates an example block lattice according to an embodiment.

FIG. 4 illustrates a block diagram of example hardware that may be used to contain or implement program instructions according to an embodiment.

### DETAILED DESCRIPTION

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

The following terms shall have, for purposes of this application, the respective meanings set forth below:

A “block” or a “node” refers to a data structure that includes a link to one or more other data structures. In certain embodiments, a block may include a grouping of data or data records. A block of a blockchain may include a link to an immediately preceding block in the blockchain, a subsequent block in the blockchain, a different block in the blockchain, or a different block in another blockchain.

A “blockchain” refers to a distributed data structure that includes a sequence of blocks that are linked together. A blockchain maintains a list of data records that are secured from tampering and modification by cryptographic signatures.

A “computing device” or “electronic device” refers to a device that includes a processor and tangible, computer-readable memory. The memory may contain programming instructions that, when executed by the processor, cause the computing device to perform one or more operations according to the programming instructions Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers (such as those used in hosted services), mainframes, virtual machines, containers, gaming systems, televisions, and mobile electronic devices such as smartphones, personal digital assistants, cameras, tablet computers, laptop computers, media players and the like. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container may also be considered to be an electronic device. In the discussion below, a client device, server device, virtual machine or container may be referred to simply as a “device” for brevity.

A “data store” refers to a tangible, computer-readable memory device, or a group of such devices. A data store may store data objects, data structures and/or the like. Example data stores include, without limitation, tables, databases, and/or the like. Except where specifically stated otherwise, the terms “memory,” “data store,” “data storage facility” and the like are intended to include single device embodiments, embodiments in which multiple memory devices together or collectively store a set of data or instructions, as well as individual sectors within such devices.

A “log record” refers to a history of one or more actions that have happened over a time period or at a specific time. For instance, a data access log record may include a description of one or more accesses to data that have happened over a time period including, as an example, an indication of who or what accessed what data, a time the access occurred, and/or other details.

A “signature” refers to data that uniquely identifies the authenticity and/or the integrity of a block or, if applicable, its log records.

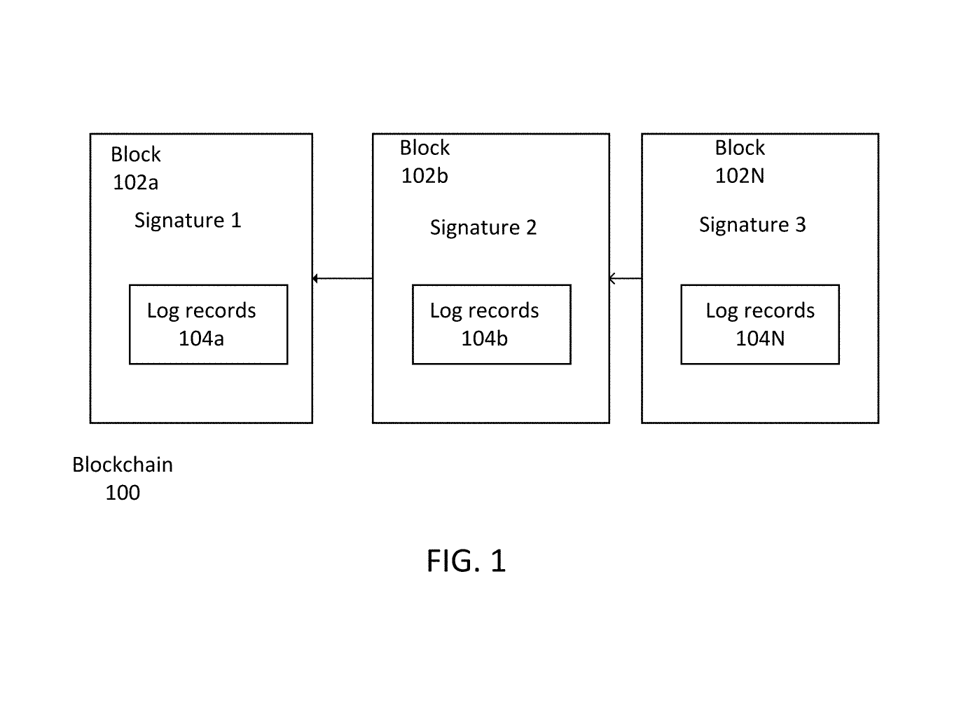

FIG. 1 illustrates an example blockchain according to an embodiment. A blockchain 100 includes one or more blocks 102a-N. Optionally, a block may include one or more log records 104a-N. As new log records are generated, a corresponding data representation of those log records are added to the blockchain 100 as part of a new block. As such, blocks 102a-N of a blockchain 100 are positioned in a linear, sequential order. For example, blocks may be in a chronological order. Blocks 102a-N in a blockchain 100 are linked to preceding blocks in the chain as illustrated in FIG. 1.

Optionally, blocks of a blockchain may occupy the same data store or memory space. Alternatively, a blockchain may be implemented as via a distributed data store. For instance, blocks of a blockchain may not occupy the same data store or memory space, but rather two or more blocks in a blockchain may be implemented as distributed data stores. A block of a blockchain may be located in a data store at a first location, while a second block of the blockchain may be located in a data store at a second location. Despite remote storage proximity to one another, the blocks may still form the blockchain as they are linked to one another by way of their signatures.

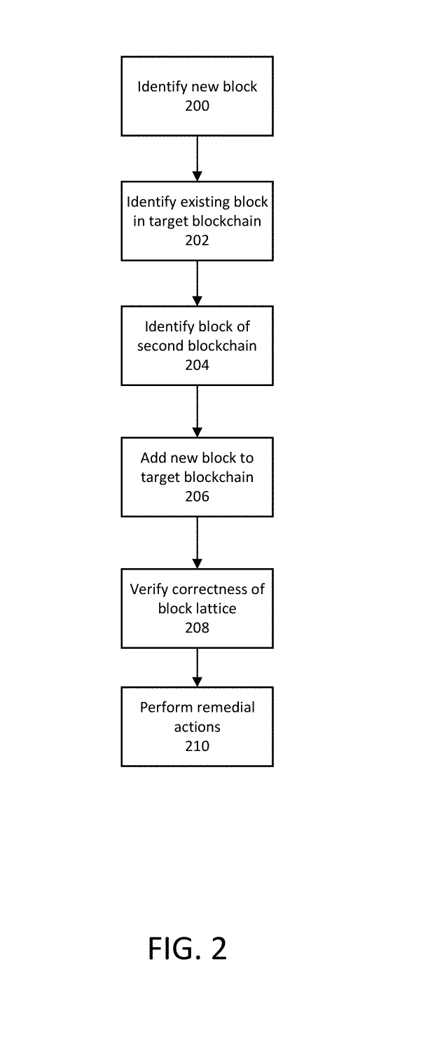

FIG. 2 illustrates a flow chart of an example method of performing tamper-evident logging according to an embodiment. Tamper-evident logging refers to a process that makes changes, modifications or access to log records easily detectable. This is true for modifications or changes made by unauthorized users who have no privileges on the system, as well as authorized users of the system, including, for example, those having root privileges.

As illustrated by FIG. 2, an electronic device identifies 200 a new block to be added to a target blockchain. In an embodiment, the new block may include one or more log records of events or occurrences that happened over a period of time. Example log records may include, without limitation, machine logs, data access logs, performance logs, transaction logs, operational logs, ledger entries, authentication logs, authorization logs, and/or the like. A log record may include log information pertaining to an occurrence, such as, for example, an indication of a user or process that performed an action, a timestamp of when such action occurred, a summary or details about what action occurred, data associated with such action, and/or the like.

In an alternate embodiment, a block may not include any log records. But rather, a block may serve to link blockchains, vouch for the authenticity of a blockchain, and/or bind the dependencies of two blockchains into a lattice.

An electronic device identifies 202 an existing block in a target blockchain. An existing block may be the final block in the sequence of the blockchain, or it may be a previous block in the sequence of the blockchain that is not the final block. For instance, an electronic device may randomly identify 202 an existing block in a target blockchain. Alternatively, an electronic device may deterministically identify 202 an existing block in a target blockchain. The identified existing block of the target blockchain is associated with a signature. The signature may be based on the signature of a block that precedes the existing block in the target blockchain. In certain embodiments, the block that precedes the existing block may immediately precede the existing block in the target blockchain. In other embodiments, the block that precedes the existing block in the target blockchain may not immediately precede the existing block but instead may be separated from the existing block by one or more intervening blocks.

For instance, the signature of the existing block may be a result of a cryptographic operation, such as, for example, a hash function, performed on the signature of a block that precedes the previous block in the target blockchain. As such, the blocks of the blockchain are inextricably linked together, and modification of one block will require modification of the previous blocks in the chain. In an embodiment, if the existing block is also the only block in the target blockchain, then the signature of the existing block may not be based on a preceding block because there is no preceding block in the chain. In this situation, the signature of the block may be a result of a cryptographic operation performed on at least part of the block, such as, for example, a portion of the block's log records.

The electronic device identifies 204 a block of a second blockchain. The second blockchain is a blockchain that is separate from and not a part of the target blockchain. In various embodiments, the target blockchain and/or the second blockchain may be associated with one or more servers, data centers and/or the like. The identified block of the second blockchain may include one or more log records, and may be associated with its own unique signature. The signature of the identified block in the second blockchain may be based on a signature that is associated with a block that immediately precedes the block in the second blockchain. For instance, the signature of the identified block may be a result of a cryptographic operation performed on the signature of the block that immediately precedes the block in the second blockchain.

When identifying 204 a block of a second blockchain, an electronic device may randomly identify a block of a second blockchain. Alternatively, an electronic device may identify a block of a second blockchain using a random shuffle approach. A potential issue with using the random choice approach described above is that there is chance, albeit a small one, that a block may go unobserved by being part of a closed cluster. For example, a system may include two loggers, A and B. Each logger may have an independent, uncorrelated stream of random numbers available to it for choosing blocks, such as, for example: A: <0, 3, 4, 6, 2, 2, 4, 2, 9, 0, 7, 5, 5, 8, 2, . . . > and B: <1, 1, 1, 1, 1, 1, 1, 1, 1, 1, 1, 1, 1, 1, 1, . . . >. Each random number may correspond to a particular block in a lattice. As A's stream contains no 1s, but B's stream contains all 1's, messages logged by A can never be entangled with messages logged by B, which causes a split in the resulting lattice. In this situation A and B are emitting messages that are each part of disjoint closed clusters.

To prevent this situation, a list of blocks may be shuffled randomly, and the shuffled list traversed in turn. A logger may generate a list of the blocks available to it. Each available block may be associated with a unique identifier, such as, for example a unique number. For example, if there are ten possible blocks available, a logger may generate the list <1, 2, 3, 4, 5, 6, 7, 8, 9>, where each number corresponds to an available block. The list is shuffled to generate, for example <5, 6, 1, 4, 7, 9, 2, 8, 3>. The logger may select the block associated with the first unique identifier in the list. Each subsequent block is shuffled against a different seed. As such, loggers send messages at a frequency of exactly 1/n, where n is the number of blocks in the lattice. Requiring that blocks have a rolling buffer size of at least 2 n further increases the likelihood that every hash issued by a block has had the opportunity to be entangled with hashes from every other block.

Alternatively, an electronic device may selectively identify a block of a second blockchain such as, for example, by identifying a most recent block in the second blockchain, selecting a block from a certain number of most recent blocks of the second blockchain, and/or the like. As another alternative, an electronic device may selectively identify 204 a block of a second blockchain having log records belonging to the same customer, user, owner, operator and/or the like as the log records of the new block. For instance, log records may be associated with a unique owner identifier. The owner identifier may correspond to the person or entity who performed or participated in an action or occurrence that is the subject of the associated log record. In another embodiment, an owner identifier may correspond to the person or entity on whose behalf an action or occurrence that is the subject of the associated log record was performed. For instance, a service provider may perform logging of customer data. In this situation, the owner identifier would refer to the customer even though the server provider actually performed the action and/or logged activities.

An electronic device may identify 204 a block second blockchain that includes log records associated with the same owner identifier. For instance, an electronic device may maintain or have access to a database or listing of blocks, log records and owner identifiers from which the electronic device may identify a block associated with the same owner identifier. In certain embodiments, if there are two or more blocks having log records associated with an owner identifier, the electronic device may randomly select a block from the group that is associated with the owner identifier.

In an embodiment, an electronic device adds 206 the new block to the target blockchain. A new block refers to a new block that is to be added to the target blockchain. The new block may include one or more log records that are to be incorporated into the blockchain. One or more loggers may add 206 a new block to be added to a target blockchain. A logger refers to a program that creates a block for a blockchain.

The electronic device adds 206 the new block to the target blockchain by linking the new block to the identified existing block of the target blockchain and by linking the new block to the identified block of the second blockchain. The electronic device generates a block signature for the new block by performing a cryptographic operation on the signature of the identified existing block in the target blockchain, and on the signature of the block of the second blockchain, and/or on one or more of the log records of the new block. For instance, the data of the log records of the new block may be conjoined with the signature of the identified existing block and the signature of the block of the second blockchain. A block signature may be generated for the block that depends on the conjoined data. For instance, a block signature may be generated for the block by performing a cryptographic operation on the conjoined data. A cryptographic operation may include, without limitation, a hash function and/or the like. An electronic device may use one or more software components, hardware components or a combination of software and hardware components to perform a cryptographic operation. Example hardware components include, without limitation, hardware chips optimized for cryptographic operations, hardware-based enclaves and/or the like.

As such, the new block is inextricably linked to both a preceding block in its own blockchain as well as another block of a different blockchain. The new block then becomes the final block of its blockchain. This linking may form a block lattice. A block lattice refers to a data representation of two or more interconnected blockchains. The electronic device associates the block signature with the new block. For example, the block signature may be added to the new block along with its log records.

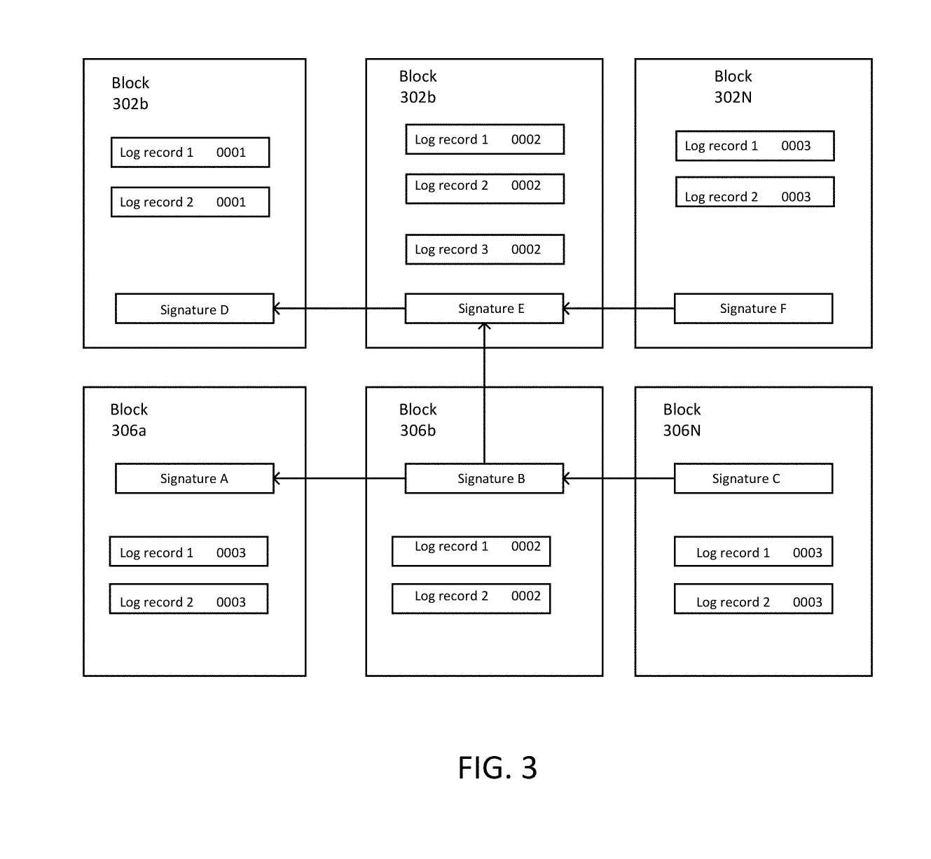

As described above, a block lattice may be formed by linking blocks of log records that are associated with the same owner (owner identifier). As such, data of a particular owner may be stored along with data of other owners, but easily searched and accessible without risking leaking information of others. FIG. 3 illustrates an example block lattice showing links between blocks having log records that share an owner identifier. As illustrated by block 302b in FIG. 3, a block may have multiple links. However, in order to maintain a chain of data belonging to an owner, each block may include at least one link to a block having the same owner identifier. For example, the log records of block 302b are associated with the owner identifier ‘0002’, and this block includes a link to a block 306b of another blockchain also having log records associated with the owner identifier ‘0002:’ However, in order to maintain the continuity of the blockchain of which block 302b is a part, block 302b also includes a link to block 302N. A block lattice formed by linking based on owner identifier may result in the ability to search and retrieve records of a particular owner more quickly and efficiently.

As described above, linking a new block to an existing block may involve including a reference of the existing block within the new block. For example, one or more of the links illustrated in FIG. 3 may be created by generating a signature for a block that is based on a signature of a block to which it is linked. For instance, the signature of block 302b (Signature E) may be based on a signature of block 306b (Signature B). Similarly, the signature of block 306b (Signature B), may be based on a signature of block 306N (Signature C). As discussed above in more detail, a block signature for a new block may be generated by performing a cryptographic operation on at least a signature of an existing block in a target blockchain.

A block lattice may be distributed across multiple systems. In other words, no single system contains the entire lattice. Rather, a lattice exists on a peer-to-peer basis, with each peer having a sublattice that proves the integrity of the other peers' sublattices.

Although the description focuses on the linking of two blockchains, it is understood that one or more blocks of a blockchain may be linked to any number of blocks from any number of blockchains in the manner described in this disclosure.

In various embodiments, a system verifies 208 the correctness of a block lattice. For instance, a system may verify the correctness of a block lattice by validating the integrity of a log message, the completeness of a log message, or the fact that a certain log message was included in a log record. A verification process can identify whether a block lattice has experienced any tampering events. A tampering event refers to an action or inaction that results in information stored by at least one block being changed, altered, deleted or otherwise changed. As an example, a verification process may verify the block signature for a target block by determining whether the block signature is the result of performing a cryptographic operation on the signatures of the blocks to which the target block is linked. If the signature of the target block is not the result of performing a cryptographic operation on the signatures of the blocks to which the target block is linked, the verification process flags a tampering event.

Block lattice verification processes can be conceptually split into complete processes that verify a complete lattice and incomplete processes that sample only part of a lattice, providing a probabilistic proof of correctness. Also, processes may be classified as one-shot, where they perform their work and then provide a single definitive response, or incremental, which operate continuously, raising alerts as they are detected.

The following are examples of algorithms that may be used within the scope of this disclosure:

Complete Bruteforce One-Shot Scan. This algorithm checks every signature in a lattice working from the oldest records forwards. The algorithm involves recalculating signatures as it proceeds, raising alerts when any signatures are found to not match. This algorithm may be used only if another, lower computational cost algorithm (e.g., Complete One-Shot Merkle Core Scan, Complete One-Shot Merkle Core Scan) has detected an inconsistency.

Since this algorithm traverses all paths of a lattice, it makes it possible to locate individual nodes in multiple sub-lattices that have been tampered with. The algorithm works by visiting the oldest records in a lattice to the newest records in the lattice. The oldest record's signature is calculated, and matched with the signature documented in the record. From this point going forward, each of the messages in the block contains a signature of the most recent log record and the preceding block (thus causing the chaining). The algorithm recalculates the signatures of the current log and the preceding block to generate a confirmatory signature, and verifies that the confirmatory signature matches the signature identified by the current log as being associated with the current log. Seeing as this is done for each node, the nodes are sequentially verified. In essence, the signature of every sublattice is calculated, and compared with the existing signature of that sublattice recursively starting with a sublattice of size one consisting of the oldest node.

Complete One-Shot Merkle Core Scan. A Merkle tree data structure has similar properties to that of block lattices, in that it may be used to similarly implement a verifiable ledger. All Merkle trees are also block lattices, but not all block lattices are Merkle trees, because Merkle trees have a strict tree structure without the cross-linking that is characteristic of block lattices. It is, however, possible to construct a Merkle tree that spans all of the nodes of an arbitrary block lattice by omitting links within the block lattice in such a way as to yield a valid tree, but retaining sufficient links to provide complete coverage. An extracted tree may be referred to as a Merkle core. Typically there may be many possible valid Merkle cores for any specific block lattice. Since such a Merkle core is likely to contain far fewer links than the block lattice from which it has been extracted, verifying the Merkle core is far less computationally costly than verifying the entire lattice, though equally effective in terms of its ability to verify correctness. A lattice may be annotated as it is constructed so that, for example, a tree is generated that closely maps to the physical topology of the underlying hardware.

A Complete One-Shot Merkle Core Scan algorithm may be used periodically to check the health of an entire block lattice. It can be used if an incremental algorithm finds errors in multiple blocks, or if the incremental algorithms finds an error in a block which is substantially low in the tree. For blocks without mutual cross-linking, it is possible to extract the minimum spanning tree, and build a Merkle tree. Once the minimum spanning tree is extracted, the Merkle tree is built by computing the signature over the hash of the log message of its nodes and its leaves' signatures. The signature at each level of the tree is verified, going from the leaves to the root. The signatures of the root are checked against the signatures witnessed by the cross-linked nodes.

One-Shot Sublattice Scan. It may be possible to extract a sublattice from the main lattice that is itself a valid lattice. This algorithm is similar to the Complete Bruteforce One-Shot Scan, but restricted only to a sublattice. This algorithm is complete with respect to the sublattice, but incomplete with respect to the main lattice.

The One-Shot Sublattice Scan may be used when a sublattice is sufficiently small that a Bruteforce verification is faster than extracting the Merkle core or if there is a need to identify individual nodes in a sublattice that have been tampered with. The verification for the One-Shot Sublattice Scan works like the Complete Bruteforce One-Shot Scan, except that the scan is limited to a sublattice. The algorithm identifies a sublattice from a block lattice. The algorithm begins by computing the signature of the oldest record in the sublattice, and comparing it with the existing signature for the record. The computation of the signature is done over the hash of log message and any other cross-linked lattice's signature, with the assumption that the other cross-linked lattice's signature is correct. The algorithm then proceeds up the chain, verifying the signature for each node, where the signature is computed over the log message for the node, and of the signatures over the sublattice until then. Again, the algorithm is recursive, starting with verifying the signature of the oldest node in the sublattice. Optionally, links to neighboring sublattices may be verified in order to detect the extreme case where an entire sublattice has been faked, with all of its hashes recalculated.

One-Shot Sublattice Merkle Core Scan. This algorithm applies a Complete One-Shot Merkle Core Scan to an extracted sublattice. Consequently, this approach is complete with respect to the sublattice, but incomplete with respect to the main lattice.

A One-Shot Sublattice Merkle Core Scan verification algorithm may be used periodically as a function of the sensitivity and security concerns of a sublattice. By omitting some of the cross-links to a sublattice, the minimum spanning tree for the sublattice is used to construct the Merkle tree for the sublattice. Starting at the leaves, the signatures are verified by recomputing the signature of the nodes, and comparing them with the existing signatures of the nodes. Since the leaves of the sublattice's Merkle tree are not necessarily the leaves of the entire block lattice, the signature may include the signatures of other cross-linked lattices. In these cases, the signatures of the cross-linked lattices are assumed to be correct. The signature of the root can be additionally verified against the signature of any witness to the root node.

One-Shot Sublattice Witness Test. In this algorithm, an extracted sublattice (assumed already to be verified) is used to catalyze the verification of the parent lattice. The sublattice is traversed. Whenever a (locally unverifiable) link is encountered to the parent lattice, a request is made to have the parent lattice return the signature relevant to the link. Normally, this should always agree with the local version, but any difference indicates that the sublattice and parent lattice have diverged. This approach makes it possible to host a sublattice within a secure enclave so that it acts as a witness to the main lattice, thereby protecting against a scenario where an attacker has somehow managed to replace the entire lattice with a (self-consistent) modified version. Typically, the sublattice would be traversed top-down, since modified nodes will cause signature changes to migrate upwards. By extension, this approach also makes it possible to construct a block lattice that is constructed solely from independent sublattices that act as witnesses to each other on a peer-to-peer basis. This approach is complete with respect to nodes in the parent lattice that are directly or indirectly observed by nodes in the sublattice. It is incomplete with respect to the entire lattice.

The One-Shot Sublattice Witness Test algorithm may be used if one or more sublattices have been used as witnesses to each other, or if one or some of the sublattices are stored in secure enclaves. If either of these conditions are true, then this would typically be the first One-Shot verification scan attempted. If inconsistencies are detected, it would then be followed by a Complete One-Shot Merkle Core Scan, or a Complete Bruteforce One-Shot Scan in order to verify the consistency of the entire lattice. The Complete Bruteforce One-Shot Scan may be used if errors are found in multiple parent to sublattice links. The verification works in a top down fashion. The witnesses stored in the secure enclaves are verified by computing the signatures of the hashes of the nodes data and the signature of the sublattice connected to that node. The key used for verification is the enclave's key, which provides us additional guarantees that the key used for signing and verification has not been tampered with, making it more difficult for an attacker to replace the lattice with another self-consistent lattice. If the lattices are witnesses to each other, the verification of the lattice still works in a top-down manner. The signatures of the lattice being verified at the head is recomputed and checked against the signature on the witness lattice. Any discrepancies in the lattice being verified would have propagated to the head and are immediately identified.

The following are examples of incremental algorithms that may be used within the scope of this disclosure:

Trivial Cyclic Scan. Any of the one-shot algorithms described above may be made to function as an incremental algorithm by running them repeatedly.

Sampling Scan. Depending on the sensitivity of the system for which the logging is done, a Check on Add verification may be used. If older data is trusted but there is low trust on the new data, a Depth-limited search may be used, since it concentrated entirely upon newer data. When the correctness of an entire block lattice needs to be verified, various options exist whose performance may be matched to the underlying system architecture. A Breadth-first search is efficient for non-distributed implementations, having the useful property of proceeding mostly linearly backwards in time. Depth-first search lends itself to distributed architectures, where it is more efficient to search each shared independently. For the Breadth-first search, beginning from a recently created node in a sublattice, the nodes are visited in a top down manner, favoring nodes of similar age first, calculating and checking the signature of each node over its data and any chained nodes linked to it against its existing signature. For the Depth-first search, nodes are visited in an order that favors visiting older nodes sooner, calculating and checking the signature of each node over its data and any chained nodes linked to it against its existing signature. Depth-limited search works similarly to Depth-first search and Breadth-first search (and indeed may be implemented as a special case of either) except that the depth is limited. The Random choice and the Random shuffle may be used as an additional sampling mechanism. In these cases, a node or set of nodes is chosen at random, and verified by recomputing the signature for the data and any other signatures chained into that node.

The following is a list of example methods by which nodes may be chosen, although it is understood that additional and/or alternate methods may be used within the scope of this disclosure:

Random choice. A node may be chosen at random. But this approach does not guarantee that a specific node will be visited within a known time limit. The probability distribution function underlying the choice need not necessarily be flat—in cases where alerts are more likely in recent nodes, the distribution may be skewed such that recent nodes are visited more often than older nodes.

Random shuffle. The list of nodes is shuffled randomly, and the sequence of randomly shuffled nodes in the list is traversed in turn. This guarantees that all nodes are visited regularly with frequency proportional to 1/N, where N is the number of nodes in the lattice. This approach is complete.

Depth-first search. In this case, nodes are visited top to bottom, with priority on visiting older nodes before newer nodes. This may have advantages in distributed implementations where the lattice is spread across many physical devices. This approach is complete.

Breadth-first search. In this case, nodes are also visited top to bottom, but with priority on newer nodes. This may be useful in cases where alerts are more likely for recent nodes than older nodes, since it will visit all the newest nodes first. It is also a complete algorithm.

Depth-limited search. One of the above algorithms may be used to select nodes, but the depth within the lattice is limited. This approach is incomplete, but in cases where alerts are most likely in recent data, it could help raise alerts more quickly. This approach may be used alongside a (slower) complete algorithm.

Check on Add. In this case, as new nodes are added to the lattice, checks on their predecessors are triggered. Optionally, these checks may proceed deeper into the lattice.

It is understood that the methods and techniques for lattice checking described above are not meant to be exhaustive, and that other lattice checking methods may be used within the scope of this disclosure.

If the system detects one or more tampering events as a result of its verification process, the system performs 210 one or more remedial actions. For example, the system may mark or otherwise identify a node corresponding to a detected tampering event. As such, the node can be retained for forensic purposes, and can still serve as a way to verify descendant nodes. As another example, the system may leave any identified nodes untouched, but may keep a list of nodes corresponding to one or more detected tampering events.

Due to properties inherent in digital electronics as typically practiced, data structures are inherently susceptible to soft errors, where single or multiple bits may be flipped. Typically, this is due to radiation effects, where a charged particle passes through a semiconductor substrate at a substantial proportion of the speed of light, leaving a cone of charge behind it and potentially causing a momentary glitch on a wire or a permanent bit flip in a memory device.

With respect to verification algorithms, bit flips due to soft errors are not easy to distinguish from deliberate tampering. To mitigate the effect of soft errors, the system may perform a bruteforce search, trying all possible single, double or possibly more, bit flips to see whether this causes all the signatures to match. If a solution is found, then this is highly likely to be a soft error which can be dealt with automatically by rewriting the node in with the corrected version.

As another mitigation, the system may refer an instance of possible tampering to a human reviewer for forensic purposes. Another mitigation may involve training a machine learning algorithm to recognize typical human or machine-generated data and distinguish it from data that has been corrupted by soft errors.

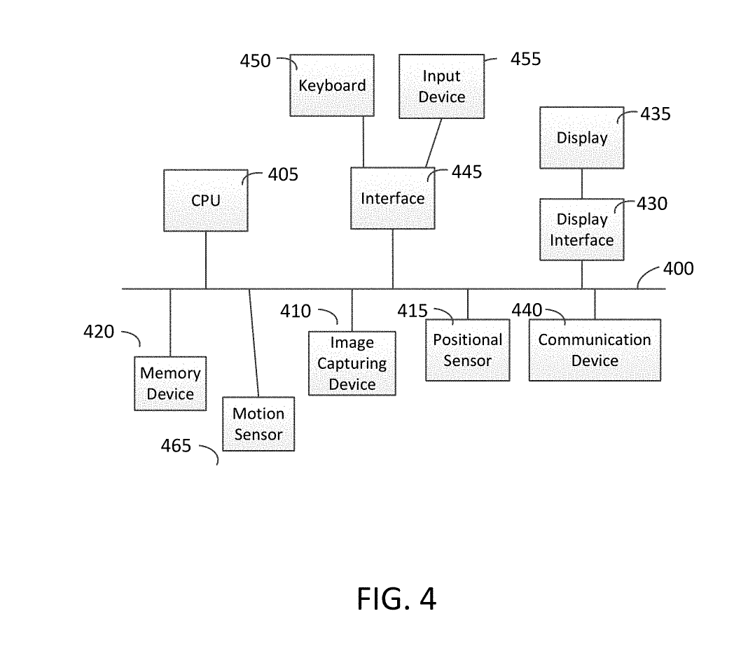

FIG. 4 depicts an example of internal hardware that may be included in any of the electronic components of the system, such as the user electronic device, or the remote server. An electrical bus 400 serves as an information highway interconnecting the other illustrated components of the hardware. Processor 405 is a central processing device of the system, configured to perform calculations and logic operations required to execute programming instructions. As used in this document and in the claims, the terms “processor” and “processing device” may refer to a single processor or any number of processors in a set of processors. Read only memory (ROM), random access memory (RAM), flash memory, hard drives and other devices capable of storing electronic data constitute examples of memory devices 410. A memory device may include a single device or a collection of devices across which data and/or instructions are stored.

An optional display interface 430 may permit information from the bus 400 to be displayed on a display device 445 in visual, graphic or alphanumeric format. An audio interface and audio output (such as a speaker) also may be provided. Communication with external devices may occur using various communication devices 440 such as a transmitter and/or receiver, antenna, an RFID tag and/or short-range or near-field communication circuitry. A communication device 440 may be attached to a communications network, such as the Internet, a local area network or a cellular telephone data network.

The hardware may also include a user interface sensor 450 that allows for receipt of data from input devices 455 such as a keyboard, a mouse, a joystick, a touchscreen (which may be part of the display), a remote control, a pointing device, a video input device and/or an audio input device. Data also may be received from an image capturing device 420 such as a scanner or camera.

In some embodiments, the system may use additional hardware components, such as a biometric device, a clock circuit and or a positioning system (such as a Global Positioning System sensor).

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of performing tamper-evident logging, the method comprising:
by an electronic device, identifying an existing block in a target blockchain, wherein the existing block is associated with a first signature;
by the electronic device, identifying a block of a second blockchain, wherein the block that is identified is associated with a second signature, wherein the second blockchain is not a part of the target blockchain; and
by the electronic device, adding a new block to the target blockchain, by:
linking the new block to both the existing block and the block of the second blockchain that is identified by generating a signature for the new block that is based on the first signature and the second signature, and
associating the signature with the new block,
wherein the target blockchain and the second blockchain are part of a block lattice.

2. The method of claim 1, wherein the target blockchain and the second blockchain are each implemented as a distributed data store.

3. The method of claim 1, wherein the new block comprises one or more log records that comprise one or more of the following:
machine logs;
data access logs;
performance logs;
operational logs;
ledger entries;
authentication logs; or
authorization logs.

4. The method of claim 1, wherein identifying the block of the second blockchain comprises randomly identifying a block from the second blockchain.

5. The method of claim 1, wherein identifying the block of the second blockchain comprises:
identifying a unique identifier associated with each block of the block lattice;
randomly shuffling the identified unique identifiers to create a shuffled list;
identifying the first unique identifier in the shuffled list; and
identifying the block corresponding the first unique identifier in the shuffled list as the block of the second blockchain.

6. The method of claim 1, wherein:
the new block comprises one or more log records that are associated with an owner identifier; and
the one or more log records of the block from the second blockchain are associated with the owner identifier.

7. The method of claim 1, wherein generating the signature for the new block comprises generating a block hash value associated with the new block by performing a cryptographic operation on the first signature and the second signature.

8. The method of claim 1, wherein generating the signature for the new block comprises:
generating a hash value for one or more of the one or more log records of the new block by:
identifying log information from one or more log records associated with the new block, and
performing a first cryptographic operation on the log information; and
generating a block hash value associated with the new block by performing a second cryptographic operation on:
the hash value for each of the one or more log records of the new block,
the first signature, and
the second signature.

9. The method of claim 1, further comprising verifying a correctness of the block lattice by determining whether the block lattice has experienced one or more tampering events.

10. The method of claim 9, wherein verifying a correctness of the block lattice comprises:
identifying a block from the block lattice that comprises an oldest record;
determining a signature for the identified block and confirming that the determined signature matches a signature that is associated with the block that comprises the oldest record; for one or more blocks in the block lattice:
determining a confirmatory signature associated with the block by calculating a signature of the block and a preceding block in the block lattice, wherein the preceding block immediately precedes the block in the block lattice; and
determining whether the confirmatory signature associated with the identified block matches a signature that is associated with the block.

11. The method of claim 9, wherein verifying a correctness of the block lattice comprises:
identifying a sublattice of the block lattice;
identifying a block from the sublattice that comprises an oldest record;
determining a signature for the identified block and confirming that the determined signature matches a signature that is associated with the block that comprises the oldest record;
for one or more blocks in the sublattice:
determining a confirmatory signature associated with the block by calculating a signature of the block and a preceding block in the block lattice, wherein the preceding block immediately precedes the block in the sublattice; and
determining whether the confirmatory signature associated with the identified block matches a signature that is associated with the block.

12. The method of claim 9, wherein verifying a correctness of the block lattice comprises:
identifying all of the blocks in the block lattice;
randomly shuffling the blocks and generating a sequenced list of the randomly shuffled blocks; and
traversing the sequenced list from a first block in the sequenced list to a last block in the sequenced list by, for each block in the sequenced list;
determining a confirmatory signature associated with the block by calculating a signature of the block and a preceding block in the block lattice if there is one, wherein the preceding block immediately precedes the block in the sublattice, and
determining whether the confirmatory signature associated with the identified block matches a signature that is associated with the block.

13. A system of performing tamper-evident logging, the system comprising:
an electronic device; and
a computer-readable storage medium comprising one or more programming instructions that, when executed, cause the electronic device to:
identify an existing block in a target blockchain, wherein the existing block is associated with a first signature,
identify a block of a second blockchain, wherein the block that is identified is associated with a second signature, wherein the second blockchain is not a part of the target blockchain, and
add a new block to the target blockchain, by:
linking the new block to both the existing block and the block of the second blockchain that is identified by generating a signature for the new block that is based on the first signature and the second signature, and
associating the signature with the new block,
wherein the target blockchain and the second blockchain are part of a block lattice.

14. The system of claim 13, wherein the target blockchain and the second blockchain are each implemented as a distributed data store.

15. The system of claim 13, wherein the new block comprises one or more log records that comprise one or more of the following:
machine logs;
data access logs;
performance logs;
operational logs;
ledger entries;
authentication logs; or authorization logs.

16. The system of claim 13, wherein the one or more programming instructions that, when executed, cause the electronic device to identify the block of the second blockchain comprise one or more programming instructions that, when executed, cause the electronic device to randomly identify a block from the second blockchain.

17. The system of claim 13, wherein the one or more programming instructions that, when executed, cause the electronic device to identify the block of the second blockchain comprise one or more programming instructions that, when executed, cause the electronic device to:
identify a unique identifier associated with each block of the block lattice;
randomly shuffle the identified unique identifiers to create a shuffled list;
identify the first unique identifier in the shuffled list; and
identify the block corresponding the first unique identifier in the shuffled list as the block of the second blockchain.

18. The system of claim 13, wherein:
the new block comprises one or more log records that are associated with an owner identifier; and
the one or more log records of the block from the second blockchain are associated with the owner identifier.

19. The system of claim 13, wherein the one or more programming instructions that, when executed, cause the electronic device to generate the signature for the new block comprise one or more programming instructions that, when executed, cause the electronic device to generate a block hash value associated with the new block by performing a cryptographic operation on the first signature and the second signature.

20. The system of claim 13, wherein the one or more programming instructions that, when executed, cause the electronic device to generate the signature for the new block comprise one or more programming instructions that, when executed, cause the electronic device to:
generate a hash value for one or more of the one or more log records of the new block by:
identifying log information from one or more log records associated with the new block, and
performing a first cryptographic operation on the log information; and
generate a block hash value associated with the new block by performing a second cryptographic operation on:
the hash value for each of the one or more log records of the new block,
the first signature, and
the second signature.

21. The system of claim 13, wherein the computer-readable storage medium further comprises one or more programming instructions that, when executed, cause the electronic device to verify a correctness of the block lattice by determining whether the block lattice has experienced one or more tampering events.

22. The system of claim 21, wherein the one or more programming instructions that, when executed, cause the electronic device to verify a correctness of the block lattice comprise one or more programming instructions that, when executed, cause the electronic device to:
identify a block from the block lattice that comprises an oldest record;
determine a signature for the identified block and confirming that the determined signature matches a signature that is associated with the block that comprises the oldest record;
for one or more blocks in the block lattice:
determine a confirmatory signature associated with the block by calculating a signature of the block and a preceding block in the block lattice, wherein the preceding block immediately precedes the block in the block lattice; and
determine whether the confirmatory signature associated with the identified block matches a signature that is associated with the block.

23. The system of claim 21, wherein one or more programming instructions that, when executed, cause the electronic device to verify a correctness of the block lattice comprise one or more programming instructions that, when executed, cause the electronic device to:
identify a sublattice of the block lattice;
identify a block from the sublattice that comprises an oldest record;
determine a signature for the identified block and confirming that the determined signature matches a signature that is associated with the block that comprises the oldest record;
for one or more blocks in the sublattice:
determine a confirmatory signature associated with the block by calculating a signature of the block and a preceding block in the block lattice, wherein the preceding block immediately precedes the block in the sublattice; and
determine whether the confirmatory signature associated with the identified block matches a signature that is associated with the block.

24. The system of claim 21, wherein the one or more programming instructions that, when executed, cause the electronic device to verify a correctness of the block lattice comprise one or more programming instructions that, when executed, cause the electronic device to:
identify all of the blocks in the block lattice;
randomly shuffle the blocks and generating a sequenced list of the randomly shuffled blocks; and
traverse the sequenced list from a first block in the sequenced list to a last block in the sequenced list by, for each block in the sequenced list;
determining a confirmatory signature associated with the block by calculating a signature of the block and a preceding block in the block lattice if there is one, wherein the preceding block immediately precedes the block in the sublattice, and
determining whether the confirmatory signature associated with the identified block matches a signature that is associated with the bl
